(19) United States
(12) Patent Application Publication
(10) Pub. No.: US 2012/0189738 A1
(43) Pub. Date: Jul. 26, 2012

(54) FISH FEED

(75) Inventors: Takeshi Miura, Minamiuwa-gun (JP); Chiemi Miura, Minamiuwa-gun (JP); Katsutoshi Itoh, Minamiuwa-gun (JP); Mitsutaka Kushima, Miyazaki-shi (JP)

(73) Assignees: ABIES CO. LTD., Miyazaki-shi ,Miyazaki (JP); EHIME UNIVERSITY, Matsuyama-shi ,Ehime (JP)

(21) Appl. No.: 13/261,145

(22) PCT Filed: Jul. 16, 2010
(86) PCT No.: PCT/JP2010/062055

§ 371 Date: Jan. 12, 2012

(30) Foreign Application Priority Data
Jul. 16, 2009 (JP) 2009-167364
Feb. 26, 2010 (JP) 2010-041478

(51) Int. Cl. A23K 1/18

(52) U.S. Cl. 426/61

(57) ABSTRACT

Due to the recent problems of higher fuel costs and exhaustion of marine resources, fish meal-free feeds have been developed. However, these feeds are insufficient from the standpoints of feed-intake and growth of fishes. Also, there has been required a feed which can economically and easily prevent or treat fish diseases and, even in the case of given in a reduced amount, ensures efficacious fish growth without disturbing the growth of fishes. Disclosed is a feed containing fly pupae and/or fly larvae. This feed can be taken at a high feeding rate by fishes, promotes the growth of the fishes having taken the same and exerts an effect of activating the immunity of the fishes.

This application is a national phase application under 35 U.S.C. §371 of International Application Serial No. PCT/JP2010/062055, filed on Jul. 16, 2010, and claims the priority benefit under 35 U.S.C. §119 of Japanese Patent Applications No. 2009-167364, filed on Jul. 16, 2009, and No. 2010-041478, filed on Feb. 26, 2010, which are hereby expressly incorporated by reference in their entirety for all purposes.

### TECHNICAL FIELD

The present invention relates to feed for fish containing fly pupae or fly larvae.

### BACKGROUND OF THE INVENTION

So far, fishmeal made from anchovy etc. has been widely used as an animal-based feed for fish farming and breeding. Japan depends most of the fishmeal distributed therein on import, which makes the price of the fishmeal very unstable. In recent years, the price of the fishmeal has become high due to the high price of fuel and decrease in fish catches. This has put pressure on the operation of fish farmers and stock farmers. Therefore, research and development of alternative feed ingredients for fishmeal has been actively carried out.

As an alternative to the fishmeal, feeds made from soymeal have been disclosed. Examples of these include: feeds prepared using combination of soybean and animal protein sources (patent document 1); feeds prepared using soybean formulated with yeast (patent document 2); pelleted mixed feed made by molding a mixture of barley and soymeal (patent document 3) etc. However, because it relies for most of the soybeans on imports, it is difficult to ensure a stable supply.

On the other hand, larvae and pupae of insects have been used traditionally as a fish food, which is expected as an alternative protein source for fishmeal. In particular, a wide attention has been given to a technology in which fly is used where waste disposal and feed production is conducted at the same time. A method in which a mixture containing shochu (a distilled spirit) lees is dealt with housefly larvae, and a method in which culture media containing solid food waste and livestock manure is dealt with housefly larvae are disclosed, and feeds containing housefly larvae obtained by these methods are also described (patent document 4 and patent document 5). Further, patent document 6 describes a method for obtaining animal resource by decomposing plant lees by drosophila or housefly. It is also described that the housefly larvae can be utilized as a feed for farmed fish (patent document 6).

The following is a list of cited prior arts and patent documents:

Patent Document 1: JP-A-1993-076291

Patent Document 2: JP-A-2002-125600

Patent Document 3: JP-A-2004-321170

Patent Document 4: Patent No. 3533466

Patent Document 5: JP-A-1998-215785

Patent Document 6: Patent No. 3564457

### SUMMARY OF THE INVENTION

### Problem to Be Solved by the Invention

However, conventional alternative feed for fishmeal has a problem that it is inferior to feed made from fishmeal in the amount eaten by fishes and the growth of the fishes. Thus, there has been a need to develop feed ingredients which will have the equal or improved effect compared to the fishmeal.

Most of the costs for farming or feeding fishes are devoted to the ingredients for the fishes. If the amount of the feed is reduced, the cost for them can also be reduced. However, this may cause an insufficient growth of the fishes. Therefore, the development of the feeds enabling efficient growth of farmed fishes without preventing the growth of fishes is demanded.

In addition, fishes may suffer from various diseases, producing large amount of dead fishes. Fish farmers stand a loss due to the death and must afford costs for disposing the dead fishes. Thus, it has been a challenge to economically and easily prevent and treat such diseases.

In the above documents, it is mentioned that fly larvae can be used as feeds. However, there is a lack of detailed description regarding the feed using the larval housefly. Thus, it was still unclear whether or not the feeds containing fish larvae can be utilized.

### Means to Solve the Problem

The present invention is a feed for fish containing fly pupae or fly larvae. The feed according to the present invention is very high in eating amount by fishes compared to a feed made from fishmeal. Further, the feed promotes the growth of the fishes having eaten the feed, and also activate immunity thereof.

In addition, the fly pupae or fly larvae contained in the feed according to the present invention can be those having been subjected to a heating process. In many of the conventional animal ingredients, it is known that such heating process causes decrease in growth effect etc. On the contrary, in the fly pupae or fly larvae contained in the feed according to the present invention, it has been found that heating process does not detract but does improve the above mentioned effect. Therefore, using the heat-treated fly pupae or heat-treated fly larvae makes it possible to obtain the feeds in which the above effect is improved.

In addition, the heating process to the feed according to the present invention can be “high temperature and high pressure process”. In many of the conventional animal ingredients, it is known that such high temperature and high pressure process causes decrease in growth effect etc. On the contrary, in the fly pupae or fly larvae contained in the feed according to the present invention, it has been found that high temperature and high pressure process does not detract but does improve the above mentioned effect. Therefore, using the fly pupae or fly larvae having been treated with high temperature and high pressure makes it possible to obtain the feeds in which the above effect is improved.

The feed according to the present invention may contain the fly pupae or fly larvae in about 0.05 wt % to about 50 wt % by dry weight based on the entire feed. The feed according to the present invention may also contain the fly pupae or fly larvae in about 0.5 wt % to about 25 wt % by dry weight based on the entire feed. By making it contain the fly pupae or fly larvae in the above mentioned range, it becomes possible to improve the effect caused by the feed according to the present invention.

Further, the feed according to the present invention may contain the fly pupae or fly larvae in about 0.1 wt % to about 100 wt % by dry weight based on the animal ingredients contained in the feed. The feed according to the present invention may also contain the fly pupae or fly larvae in about 1 wt % to about 50 wt % by dry weight based on the animal ingredients contained in the feed. By making it contain the fly pupae or fly larvae in the above mentioned range, it becomes possible to improve the effect caused by the feed according to the present invention.

The feed according to the present invention may contain the fly pupae in about 0.5 wt % to about 7.5 wt % by dry weight based on the entire feed. The feed according to the present invention may also contain the fly pupae in about 1 wt % to about 15 wt % by dry weight based on the entire feed. By making it contain the fly pupae in the above mentioned range, it becomes possible to improve the effect caused by the feed according to the present invention.

The feed according to the present invention may contain the fly larvae in about 5 wt % to about 50 wt % by dry weight based on the entire feed. The feed according to the present invention may also contain the fly larvae in about 10 wt % to about 100 wt % by dry weight based on the animal ingredients contained in the feed. By making it contain the fly larvae in the above mentioned range, it becomes possible to improve the effect caused by the feed according to the present invention.

### Effect of the Invention

The feed according to the present invention has a high degree of amount eaten by fishes compared to conventional feeds, and promotes the growth of fishes having eaten the feed according to the present invention. Further, weight increase factor (the amount of feed (kg) needed to increase the weight of fish by 1 kg) is extremely low compared to conventional feeds and it is possible to cause effective growth of the fishes. Particularly important is that these effects are higher in the feed according to the present invention than in the one made from fishmeal.

Further, the feed according to the present invention also has an effect to activate the immunity of the fish having eaten the feed. Using the feed according to the present invention makes fishes healthy and decreases the amount of dead fishes.

In addition, the fly larvae or fly pupae is produced from organic wastes, and the method for production thereof is very easy. Therefore, the feed according to the present invention can be supplied stably and economically.

### BRIEF DESCRIPTION OF THE DRAWINGS

FIG. 1 shows the rate of neutrophil phagocytosis of red sea breams which were fed on feeds according to the present invention.

FIG. 2 shows neutrophil phagocytosis beads number per cell of red sea breams which were fed on feeds according to the present invention.

FIG. 3 is a micrograph showing the red sea bream neutrophils that were fed on feeds according to the present invention.

FIG. 4 shows the amount of weight growth of red sea breams that were fed on feeds according to the present invention.

FIG. 5 shows the amount of the growth in the length of the tail fin of red sea bream that were fed on feeds according to the present invention.

FIG. 6 shows neutrophil phagocytosis beads number per cell of red sea breams which were fed on feeds according to the present invention.

FIG. 7 shows the amount of weight growth of red sea breams that were fed on feeds according to the present invention (23rd day of breeding).

FIG. 8 shows the amount of weight growth of red sea breams that were fed on feeds according to the present invention (35th day of breeding).

FIG. 9 shows the amount of the growth in the length of the tail fin of red sea bream that were fed on feeds according to the present invention (23rd day of breeding).

FIG. 10 shows the amount of the growth in the length of the tail fin of red sea bream that were fed on feeds according to the present invention (35th day of breeding).

FIG. 11 shows changes in weight of red sea bream that were fed on feeds according to the present invention in a long-term feeding in sea surface preserve.

FIG. 12 shows changes in the length of the tail fin of red sea bream that were fed on feeds according to the present invention in a long⁻term feeding in sea surface preserve.

FIG. 13 shows the rate of neutrophil phagocytosis of red sea breams which were fed on feeds according to the present invention.

FIG. 14 shows neutrophil phagocytosis beads number per cell of red sea breams which were fed on feeds according to the present invention.

FIG. 15 shows the amount of weight growth of red sea breams that were fed on feeds according to the present invention.

FIG. 16 shows the amount of the growth in the length of the tail fin of red sea bream that were fed on feeds according to the present invention.

### DETAILED DESCRIPTION OF THE INVENTION

The following describes embodiments of the feed according to the present invention, which however in no way limits the scope of the present invention.

The feed according to the present invention is a feed containing fly pupae and/or fly larvae. The feed according to the invention has high degree of the amount eaten by fishes, and has effects for promoting the growth of fishes having eaten the feed and activate the immunity of the fishes. Flies grow in an environment where bacteria and virus are abundant during the period from larvae to pupae. Therefore, the immunity function of flies is highly developed. Thus, the fly larvae and pupae are considered to contain effective components s for fishes.

Flies are insects belonging to fly order (dipterous order) and grow from eggs to larvae, pupae, and adults, changing their forms. There are such families as Muscidae, Fannia canicularis, Scatophagidae, Anthomyiidae, Sarcophagidae, Calliphoridae, Drosophilidae and others and such species as Houseflies, Himefunbae, Ookurobae, Greenbottle fly, Centimeter flesh fly, Drosophila melanogaster and others.

In the present invention, it is preferable to use housefly belonging to housefly families (academic name: Musca Domestica). The houseflies are present in all over the world. The houseflies grow fast and can be produced with simple equipment, thus are suitable for mass production.

The fly pupae or fly larvae contained in the feed according to the present invention can be produced by the method described hereinbelow. First, eggs of houseflies are injected onto a culture containing organic materials suitable for the growth of flies. As the environment during production, it is favorable to maintain temperature in between 25 to 40 degrees Celsius and humidity in between 20 to 90%. The flies become larvae in one or two days after the injection of the eggs. The larvae have a nature to go out from dark place in three to five days after pupation. Therefore, by setting collecting box to the place where the flies go out, the flies by themselves move into the box, and can be collected easily. The flies having moved into the collecting box pupate within one or two days after moving.

The feed according to the present invention may contain the followings as feed ingredients in addition to the fly pupae or fly larvae: animal ingredients such as fishmeal, meat powder, bone meal powder, krill meal, squid meal and others; plant ingredients such as wheat, soymeal, oil meal, sake lees, rice bran, starch and others; and other ingredients such as yeast, sea weed powder, vitamin, mineral, amino acid, sodium carboxymethylcellulose (hereinafter called as CMC) and others.

The feed according to the present invention may contain the fly pupae and/or fly larvae preferably in about 0.05 wt % to about 50 wt % and more preferably in about 0.5 wt % to about 25 wt % by dry weight based on the entire feed. By making it contain the fly pupae and/or fly larvae in the above mentioned range, it becomes possible to improve the effect caused by the feed according to the present invention.

The feed according to the present invention may contain the fly pupae in about 0.5 wt % to about 7.5 wt % by dry weight based on the entire feed. Also, the feed according to the present invention may contain the fly larvae in about 5 wt % to about 50 wt % by dry weight based on the entire feed. By making it contain the fly pupae or fly larvae in the above mentioned range, it becomes possible to improve the effect caused by the feed according to the present invention.

The fly pupae and/or fly larvae can be contained in the feed as an animal ingredient. Exchanging all or part of the animal ingredients contained in conventional feeds with fly pupae or fly larvae provides the above mentioned effects without negatively affecting growth rate of the fishes having eaten the feed. Therefore, it can be said that the fly pupae or fly larvae can replace all or part of other animal ingredients.

The feed according to the present invention may contain the fly pupae and/or fly larvae preferably in about 0.1 wt % to about 100 wt % and more preferably in about 1 wt % to about 50 wt % by dry weight based on the animal ingredients contained in the feed. By making it contain the fly pupae and/or fly larvae in the above mentioned range, it becomes possible to improve the effect caused by the feed according to the present invention.

More preferably, the feed according to the present invention may contain the fly pupae in about 1 wt % to about 15 wt % by dry weight based on the animal ingredients contained in the feed. The feed according to the present invention may also contain the fly larvae in about 10 wt % to about 100 wt % by dry weight based on the entire feed. By making it contain the fly pupae in the above mentioned range, it becomes possible to improve the effect caused by the feed according to the present invention.

Therefore, according to the present invention, about 0.05 wt % to about 100 wt %, preferably about 1 wt % to about 50 wt %, of fishmeal by dry weight can be replaced with the fly pupae and/or fly larvae.

The fly pupae or fly larvae can be artificially produced. Thus, it becomes possible to develop feeds that have reduced burden on natural environment. Especially, fishmeal contained in many feeds are produced by catching natural fishes, causing over fishing of natural fishes, and thus alternative ingredients for fishmeal have been demanded.

Here, if the replacement rate for fishmeal is 50 wt %, it means that half by weight of the fishmeal contained in conventional feed are replaced with other ingredients. Similarly, if the replacement rate for fishmeal is 100 wt %, it means that all of the fishmeal contained in conventional feed is replaced with other ingredients.

The feed according to the present invention may contain fly pupae or fly larvae having been subjected to heat treatement. In the fly pupae or fly larvae contained in the feed according to the present invention, it has been found that heating process does not detract but does improve the above mentioned effect. Therefore, using the heat-treated fly pupae or heat-treated fly larvae makes it possible to obtain the feeds in which the above effect is improved.

In addition, the feed according to the present invention may contain fly pupae or fly larvae having been treated with high temperature and high pressure. In the fly pupae or fly larvae contained in the feed according to the present invention, it has been found that high temperature and high pressure process does not detract but does improve the above mentioned effect. Therefore, using the fly pupae or fly larvae having been treated with high temperature and high pressure makes it possible to obtain the feeds in which the above effect is improved.

The heating process or the high temperature and high pressure process can be conducted solely on fly pupae or fly larvae or can be conducted on fly pupae or fly larvae together with other feed ingredients.

The heating process means a treatment with high temperature such as boiling treatment, dry heat treatment, wet heat treatment, friction heat treatment, and other treatments; and examples of heating process include the high temperature and high pressure process. Temperature for the heating process is, for example, between about 40 and about 300 degrees Celsius, and preferably between about 80 and about 200 degrees Celsius, and more preferably between about 100 and about 130 degrees Celsius. Time period for the heating process is, for example, between about 5 seconds and about 1 hour.

The high temperature and high pressure process means a treatment with high temperature and high pressure condition and includes treatments by autoclave or extruder. Conditions such as temperature, time period, pressure, etc. for the high temperature and high pressure process are not limited. Temperature for the high temperature and high pressure process is, for example, between about 40 and about 300 degrees Celsius, and preferably between about 80 and about 200 degrees Celsius, and more preferably between about 100 and about 120 degrees Celsius. Time period for the high temperature and high pressure process is, for example, between about 5 seconds and about 1 hour. Pressure for the high temperature and high pressure process is higher than atmospheric pressure and, for example, between 0.15 MPa and 50 MPa.

The treatment by extruder can be conducted using extruders equipped with single-axis or multi-axes screw. The feed ingredients are mixed by the screw in the extruder, treated with high temperature and high pressure, and extruded from die. Rotational frequency of the screw of the extruder is not limited but for example falls in between 20 rpm and 200 rpm.

Fly pupae or fly larvae used in the present invention can be subjected to other processes such as grinding, powder processing, or drying processes in addition to the above processes.

The feed according to the present invention can be made into solid feed by molding feed ingredients. As solid feeds, for example, moist pellets, extruded pellets, and others can be exemplified.

Moist pellets have advantages such as being difficult in dispersing in the sea, having high degree of amounts eaten by fishes, and being able to be produced with stable quality. Extruded pellets are feeds being treated with high temperature and high pressure and molded by extruder. Extruded pellets have the same advantages as in moist pellets and have further advantages such as having high water resistivity and having high digesting and absorbing rate in fishes having eaten the feed.

Moist pellets can be molded using a granulator for moist pellets. Extruded pellets can be molded by mixing the feed ingredients in the extruder and extruded from die. The size of the pellets in the present invention is not limited and can arbitrary be selected from, for example, between 0.1 and 30 mm in diameter depending on the species of fish fed by the feed

The feed according to the present invention can be used for seed production and breeding of edible fishes such as bream, yellowtail, tuna, flounder, puffer fish, eel and others; and can also be used for seed production and breeding of ornamental fishes such as carp, goldfish, tropical fishes and others.

By making fishes eat the feed according to the present invention, their immunity can be activated. Immunity of fishes can be divided into natural immunity and acquired immunity, and various types of cells work for each of them. In natural immunity, white blood cell such as neutrophil and macrophage has phagocytic function in which it recognizes bacteria or foreign bodies having intruded into living body and swallows and destructs them. Further, macrophages present antigen and immunity response depending on the antigen happens (acquired immunity). Helper T cell having been presented the antigen will be activated and will activate and promote growth of B cells and cell disorder T cells. Antibodies produced by B cells and cell disorder T cells will attack and destruct the foreign bodies. In addition, interferon will be secreted from T cells or B cells etc. opposing to the intrusion of the foreign bodies, and will stimulate the immunity reactions.

By giving the feed according to the present invention to farmed fish, it was confirmed that the operation of neutrophil, which takes important part in natural immunity, had been activated. As mentioned, natural immune system and acquired immune system cooperate in a complex manner, and the entire immune system is activated by interferon etc. Thus, the feed according to the present invention is considered to activate the entire immune system.

In addition, the feed according to the present invention has higher degree of amount eaten by fishes compared to conventional feed and has an effect of promoting growth of the fishes having eaten the feed. The feed is particularly effective compared to the conventional one in that it can promote growth of fishes even in severe conditions such as in cold seasons.

### EXAMPLES

Furthermore, the present invention will be described in details using examples, but the invention is not limited to these examples.

### 1. Preparation of Feed for Fish

Housefly pupae or housefly larvae obtained from organic waste was used for producing feed for fish. Frozen housefly pupae was crushed with Iwatani Millser (IFM-80DG; Iwatani Corporation) or Tiger Millser (SKP-C701DE; Tiger Corporation), wrapped in gauze, and squeezed. Feed ingredients containing housefly pupae was mixed, water was added, stirred until the feed ingredients became homogeneous, and formed into moist pellet whose diameter is 4 mm to 5 mm and length is 5 mm to 10 mm using drying granulator (MGD-5; AKIRA KIKO Corporation). Heating process was conducted by friction heat generated during the granulation.

Further, housefly larvae obtained from organic waste was heat-treated by boiling (about 10 minutes; about 100 degrees Celsius), dried under the sun, and moist pellet was made by the same method as described above.

### 2. Verifying the Effect of Feed Containing Fly Pupae (1)

Feed for fish containing fly pupae was produced and its effect was verified. Three kinds of feeds for fish (Example 1, Example 2, and Comparative Example 1) were produced. Table 1 shows the composition of feed ingredients contained in 100 g (by dried weight) of the produced feed for fish. The feed of Example 1 contained housefly pupae in 0.75 wt % by dried weight based on the entire feed ingredients, and in 1.5 wt % by dried weight based on the entire animal ingredients. The feed of Example 2 contained housefly pupae in 7.5 wt % by dried weight based on the entire feed ingredients, and 15 wt % by dried weight based on the entire animal ingredients.

TABLE 1

| Feed | | | |
|---|---|---|---|
| Ingredients | Exam- | Exam- | Comparative |
| (g) | ple 1 | ple 2 | Example 1 |
| Housefly pupae | 0.75 | 7.5 | 0 |
| Fishmeal | 49.25 | 42.5 | 50 |
| Wheat | 24 | 24 | 24 |
| Soybean | 24 | 24 | 24 |
| Vitamin | 1 | 1 | 1 |
| CMC | 1 | 1 | 1 |

As test fishes, 72 red sea breams born on the year whose body weight (BW) was 48.2±0.6 g and tail fin length (FL) was 136.5±0.6 mm were used. They were divided into three groups (24 fishes for each), and each of them was fed with corresponding feeds only, and the effects on the test fishes was analyzed. The feed was given two times a day, each time up to the satiation amount. The water temperature for feeding was 17.0 to 23.0 degrees Celsius, and average water temperature was 20.0 degrees Celsius.

### 2.1 Analysis of the Effect on Immunity Activation

Effects of feed on immunity activation in red sea bream was evaluated using white blood cell phagocytosis as an indicator. 2% of Proteose Peptone was administered into abdominal cavity of ten-day-old red sea bream. Then the red sea bream was fed for 96 hours, and neutrophil leached to the abdominal cavity was collected. Phagocytosis capability was evaluated using fluorescent latex beads (3 μm) as an object of phagocytosis. Neutrophil was cultured for 1 hour in culture fluid to which the beads were added. Then the ratio of the neutrophil having ingested the latex beads (phagocytosis ratio) and the number of ingested latex beads per cell of neutrophil (phagocytosis beads number) was evaluated.

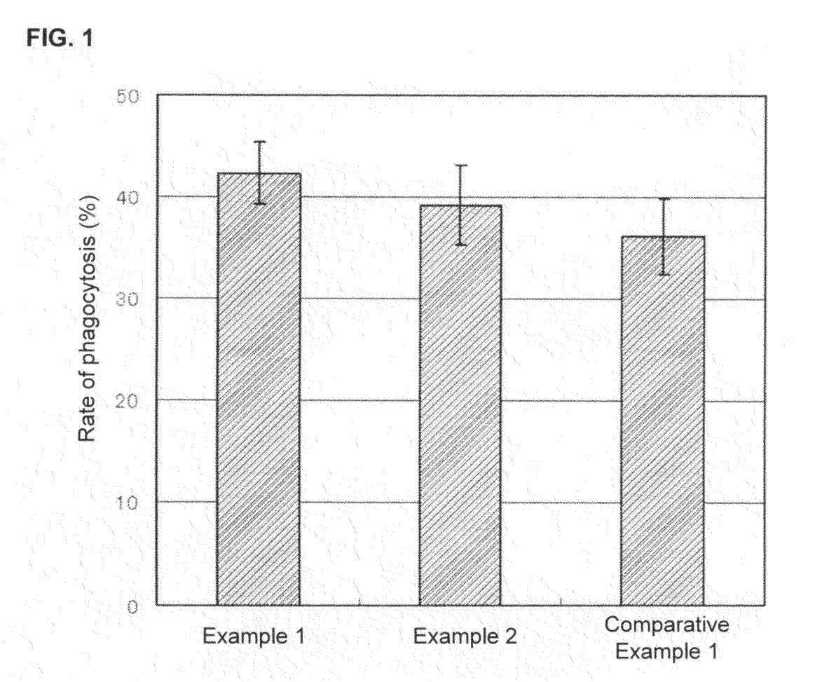

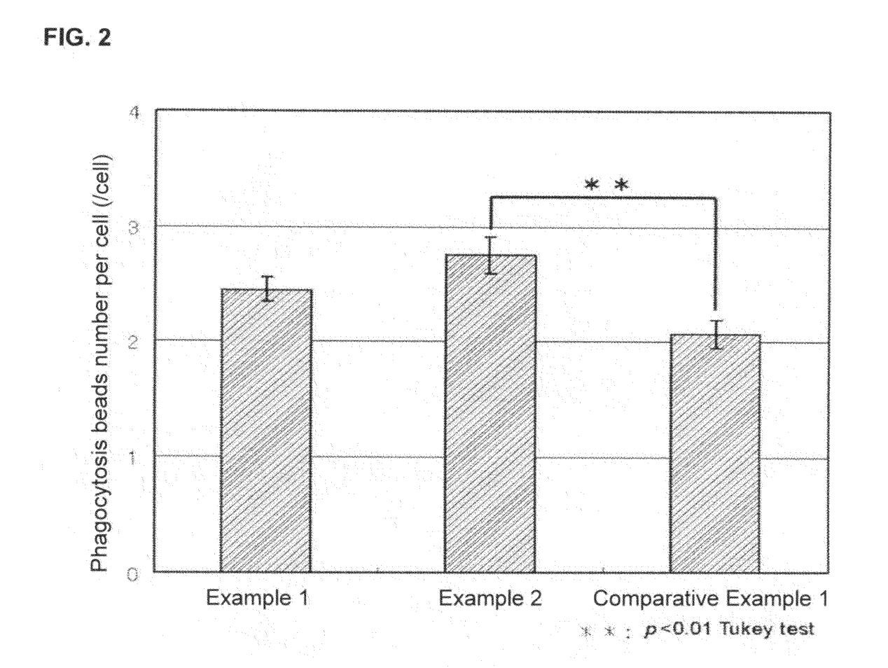

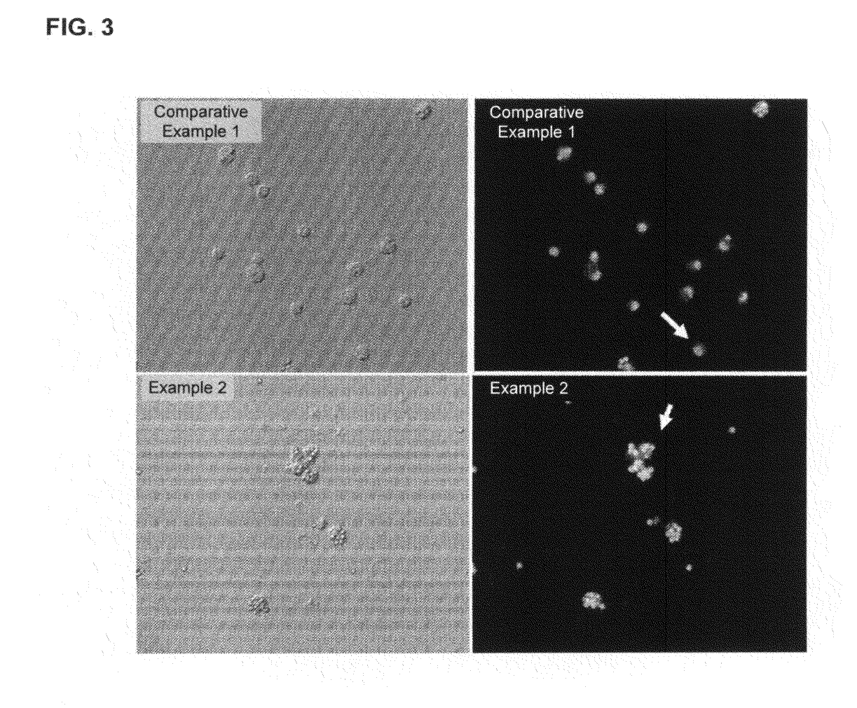

As shown in FIG. 1, the group having been given the feed of Example 1 and Example 2 was significantly high in the phagocytosis ratio compared to the one having been given the feed of Comparative Example 1. Further, as shown in FIG. 2, the phagocytosis beads number per cell increased depending on the amount of housefly pupae. In the group having been given Example 2 which contains 7.5 wt % of housefly pupae, the number was 2.75/Cell, which was very high compared to the group having been given Comparative Example 1 (2.07/Cell). FIG. 3 shows micrograph pictures. As shown in the arrow on the figure of comparative Example 1, the neutrophil of the red sea bream did not ingest latex beads, and only the nucleus of the neutrophil was dyed. On the other hand, the neutrophil of the red sea bream having been given the feed of Example 2 was observed to have ingested a plurality of latex beads as shown in the arrow on the figure.

### 2.2 Analysis of Growth-Promoting Effect

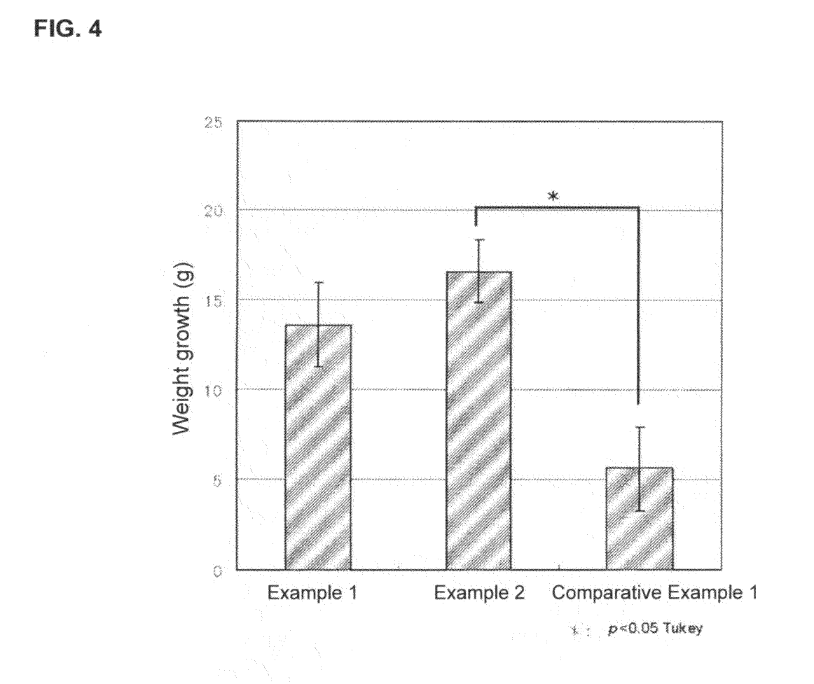

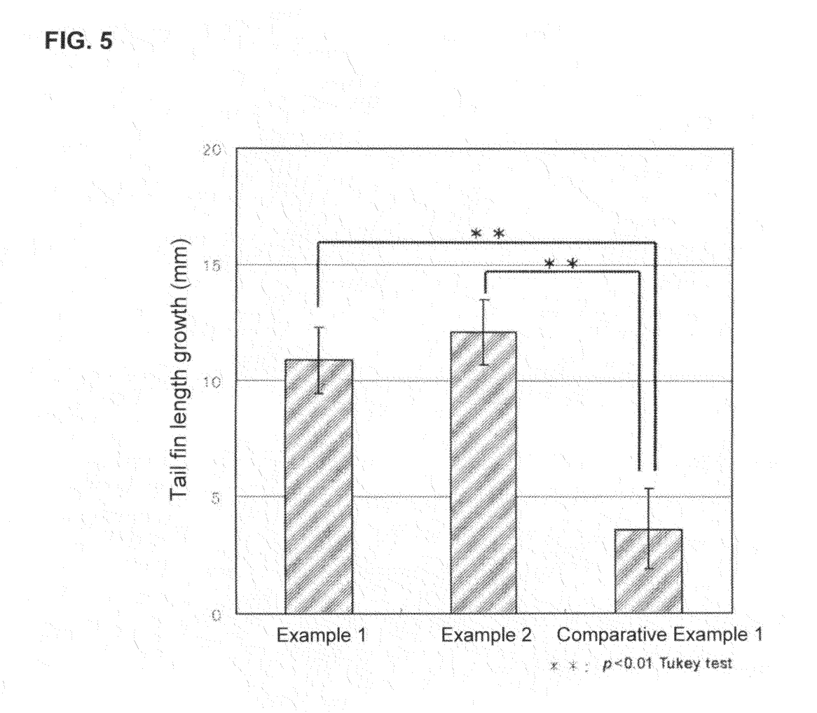

After breeding for 35 days, body weight (BW) and tail fin length (FL) of red sea bream was measured, and the growth amount was calculated based on the difference with the values before the experiment. FIG. 4 shows the growth amount of BW. In the group having been given the feed of Comparative Example 1, the growth amount was 5.6 g and the growth rate was 13.6%. In the group having been given the feed of Example 12, the growth amount was 16.7 g and the growth rate was 34%. FIG. 5 shows the growth amount of FL. In the group having been given the feed of Comparative Example 1, the growth amount was 3.6 mm and the growth rate was 2.76%. In the group having been given the feed of Example 2, the growth amount was 12.1 mm and the growth rate was 13.6%. As described, it was revealed that the feed containing fly pupae can activate immunity of fishes and strikingly promotes the growth of the fishes.

### 2.3 Analysis of Feeding Promotion and Weight Increase Factor

Further, Table 2 shows the amount of feeds eaten by a fish and weight increase factor during the feeding period. The amount of feeds eaten by a fish was higher in Examples 1 and 2 than in Comparative Example 1, which shows that the feeds of Examples 1 and 2 attracted fishes more readily. Weight increase factor (the amount of feed (kg) needed to increase the weight of farmed fish by 1 kg) was 5.27 for the feed of Comparative Example 1, 2.59 for that of Example 1, and 2.69 for that of Example 2. Thus, it was revealed that the feed according to the present invention makes fishes grow more efficiently.

TABLE 2

| | Exam- | Exam- | Comparative |
|---|---|---|---|
| | ple 1 | ple 2 | Example 1 |
| Amount of feeds eaten | 35.7 | 44.08 | 29.20 |
| by a fish (g/piece) | | | |
| Weight increase factor | 2.59 | 2.69 | 5.27 |

### 3. Verifying the Effect of Feed Containing Fly Pupae (2)

In addition, feed for fish containing fly pupae was produced and its effect was verified. Five kinds of feeds for fish (Example 3, Example 4, Example 5, Example 6, and Comparative Example 1) were used. Table 3 shows the composition of feed ingredients contained in 100 g (by dried weight) of the produced feed for fish. The feed of Example 3 contained housefly pupae in 0.05 wt % by dried weight based on the entire feed ingredients, and in 0.1 wt % by dried weight based on the entire animal ingredients. The feed of Example 4 contained housefly pupae in 0.5 wt % by dried weight based on the entire feed ingredients, and 1 wt % by dried weight based on the entire animal ingredients. The feed of Example 5 and 6 each contained housefly pupae in 5 wt % by dried weight based on the entire feed ingredients, and 10 wt % by dried weight based on the entire animal ingredients.

TABLE 3

| Feed | | | | | |
|---|---|---|---|---|---|
| Ingredients | Exam- | Exam- | Exam- | Exam- | Comparative |
| (g) | ple 3 | ple 4 | ple 5 | ple 6 | Example 1 |
| Housefly | 0.05 | 0.5 | 5 | 5 | 0 |
| pupae | | | | (high temper- | |
| | | | | ature and | |
| | | | | high pressure | |
| | | | | process) | |
| Fishmeal | 49.95 | 49.5 | 45 | 45 | 50 |
| Wheat | 24 | 24 | 24 | 24 | 24 |
| Soybean | 24 | 24 | 24 | 24 | 24 |
| Vitamin | 1 | 1 | 1 | 1 | 1 |
| CMC | 1 | 1 | 1 | 1 | 1 |

In Example 6, housefly pupae having been treated with high temperature and high pressure was used. Frozen housefly pupae were subjected to high temperature and high pressure process using autoclave, the condition of which was 2 atm (about 0.2 MPa), 121 degrees Celsius, and 20 min. The treated was crushed, squeezed, and mixed with other feed ingredients in the same way as described in section 1, thereby forming the feed for fish.

As test fishes, 105 red sea breams born on the year whose average body weight (BW) was 45.2±2.23 g and average tail fin length (FL) was 133.6±2.70 mm were used. They were divided into five groups (14 fishes for each), and each of them was fed with corresponding feeds only, and the effects on the test fishes was analyzed. The feed was given two times a day, each time up to the satiation amount. The water temperature for feeding was 23.6 to 28.5 degrees Celsius, and average water temperature was 25.8 degrees Celsius.

### 3.1 Analysis of the Effect on Immunity Activation

Effects of feed on immunity activation in red sea bream was evaluated using white blood cell phagocytosis as an indicator. The number of ingested latex beads per cell of neutrophil (phagocytosis beads number) was evaluated using 7 fishes for each group and in the same way as in section 2.1.

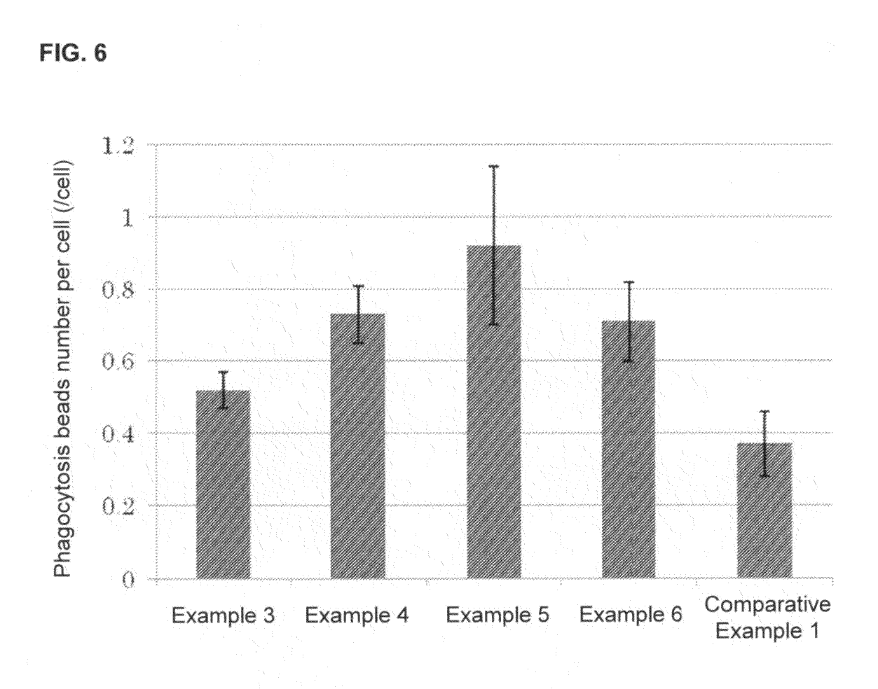

As shown in FIG. 6, the value for the group having been given the feed of Examples 3 to 6 (0.52/Cell to 0.92/Cell) was significantly high compared to the one having been given the feed of Comparative Example 1 (0.37/Cell).

### 3.2 Analysis of Growth-Promoting Effect

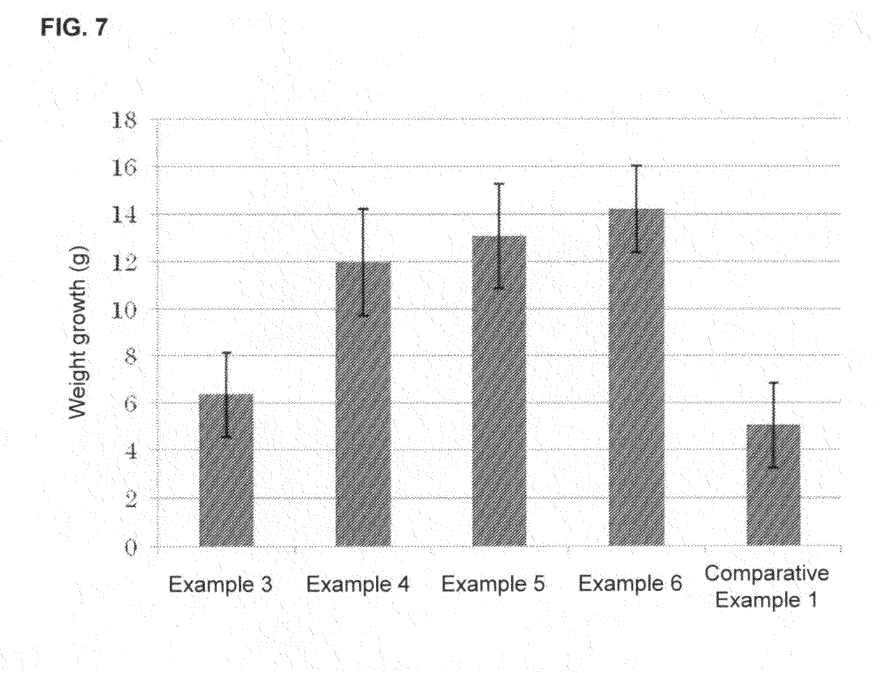

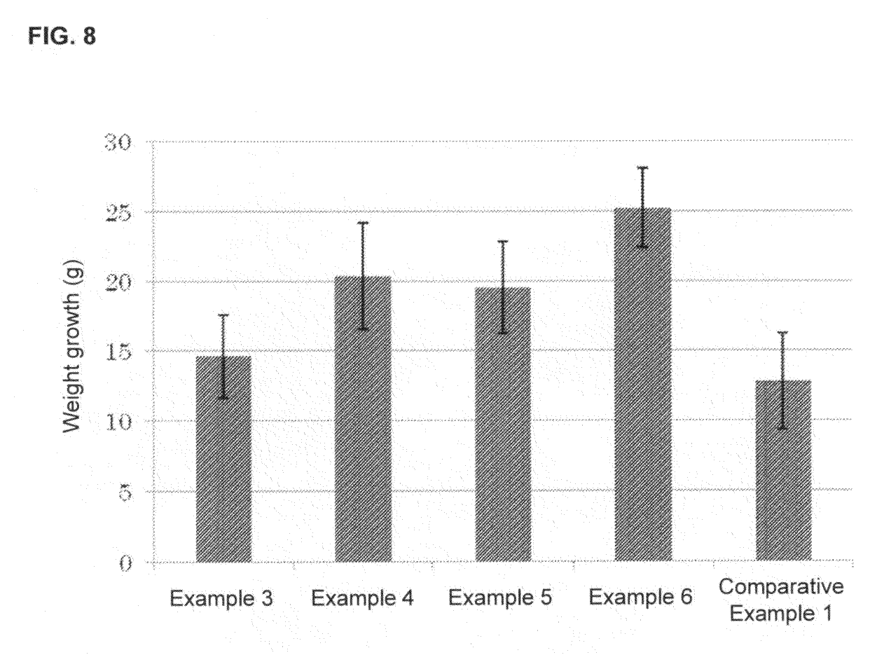

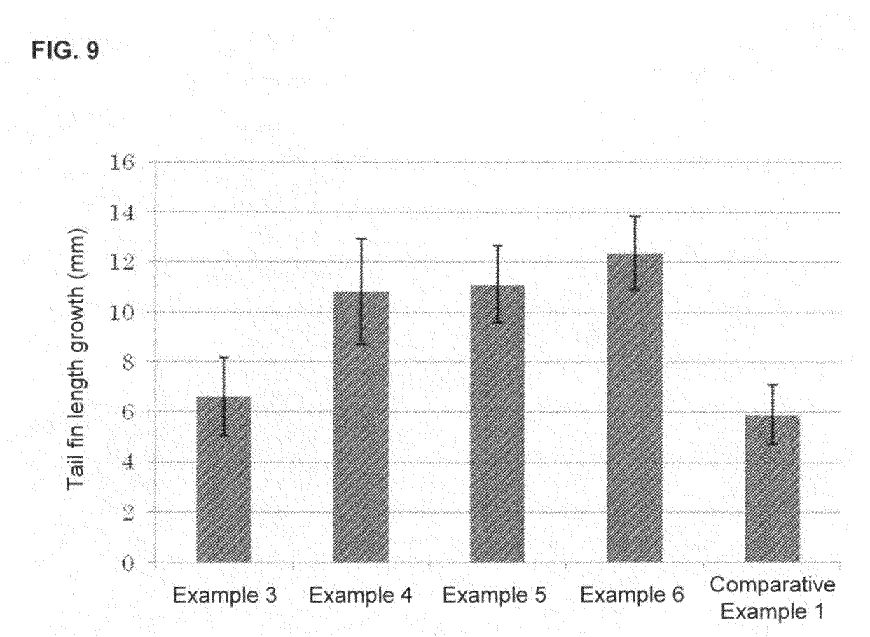

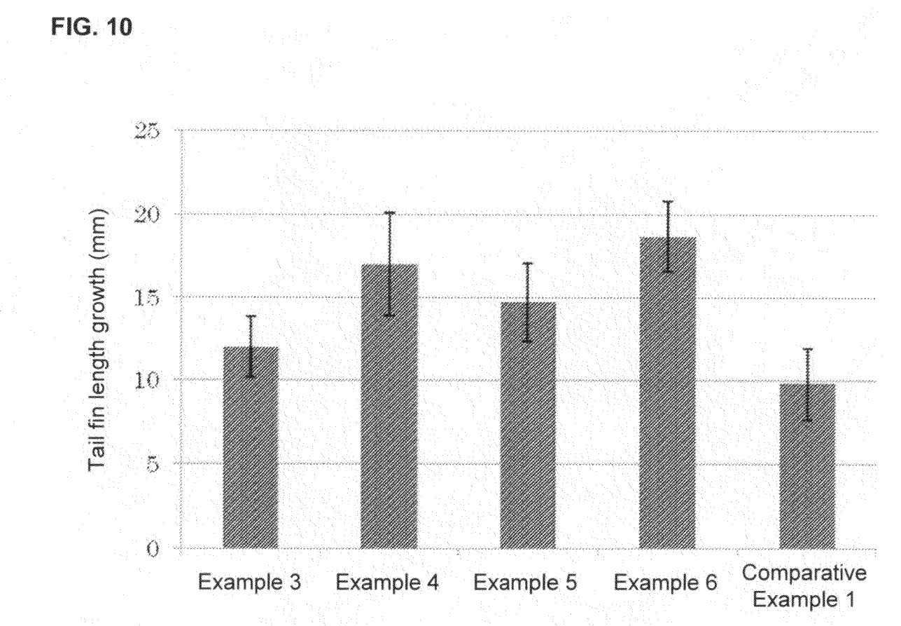

After breeding for 23 days and 35 days, body weight (BW) and tail fin length (FL) of red sea bream was measured using 14 fishes for each group, and the growth amount was calculated based on the difference with the values before the experiment. FIG. 7 shows the growth amount of BW on the 23rd day. FIG. 8 shows the growth amount of BW on the 35th day. FIG. 9 shows the growth amount of tail fin length on the 23rd day. FIG. 10 shows the growth amount of tail fin length on the 35th day. In any cases, the red sea bream having been given the feed according to the present invention grows more efficiently than that having been given the feed of comparative Example. In particular, the feed of Example 6 which contains housefly pupae having been treated with high temperature and high pressure was revealed to have the most significant effect.

### 3.3 Analysis of Feeding Promotion and Weight Increase Factor

Further, Table 4 shows the amount of feeds eaten by a fish, the amount of weight increase, and weight increase factor (the amount of feed (kg) needed to increase the weight of farmed fish by 1 kg) on the 23rd day. The amount of feeds eaten by a fish was higher in the feed according to the present invention than in the feed of Comparative Example, which shows that the feeds according to the present invention attracted fishes more readily. Weight increase factor was lower in the feeds of Examples 3 to 6 than in the feed of Comparative Example 1. Thus, it was revealed that the feed according to the present invention makes fishes grow more efficiently. Further, the feed of Example 6 which contains housefly pupae having been treated with high temperature and high pressure was revealed to show the highest amount of feeds eaten by a fish.

TABLE 4

| | Exam- | Exam- | Exam- | Exam- | Comparative |
|---|---|---|---|---|---|
| | ple 3 | ple 4 | ple 5 | ple 6 | Example 1 |
| Amount of | 35.78 | 44.02 | 43.13 | 51.22 | 33.68 |
| feeds eaten | | | | | |
| by a fish (g/ | | | | | |
| piece) | | | | | |
| Amount of | 6.35 | 11.96 | 13.08 | 14.19 | 5.308 |
| weight | | | | | |
| increase (g) | | | | | |
| Weight | 5.63 | 3.68 | 3.30 | 3.61 | 6.69 |
| increase | | | | | |
| factor | | | | | |

### 4. Verifying the Effect of Feed Containing Fly Pupae (3)

In addition, effects of the feed for fish according to the present invention in a long-term feeding in sea surface preserve were examined. Two kinds of feeds for fish (Example 7 and Comparative Example 1) were produced. Table 5 shows the composition of feed ingredients contained in 100 g (by dried weight) of the produced feed for fish. The feed of Example 7 contained housefly pupae having been subjected to high temperature and high pressure process using autoclave, the condition of which was 2 atm (about 0.2 MPa), 121 degrees Celsius, and 20 min, in 1 wt % by dried weight based on the entire feed ingredients, and in 2 wt % by dried weight based on the entire animal ingredients.

TABLE 5

| Feed | | |
|---|---|---|
| Ingredients | Exam- | |
| (g) | ple 7 | Comparative Example 1 |
| Housefly pupae | 1 | 0 |
| | (high temperature and | |
| | high pressure process) | |
| Fishmeal | 49 | 50 |
| Wheat | 24 | 24 |
| Soybean | 24 | 24 |
| Vitamin | 1 | 1 |
| CMC | 1 | 1 |

As test fishes, 500 red sea breams for each group whose average body weight (BW) was 130.7±2.59 g and average tail fin length (FL) was 45.0±1.25 mm were used. They were fed in a sea surface preserve of 4 m×4 m×4 m, and the feed was given one or two times a day, each time up to the satiation amount.

### 4.1 Analysis of Growth-Promoting Effect

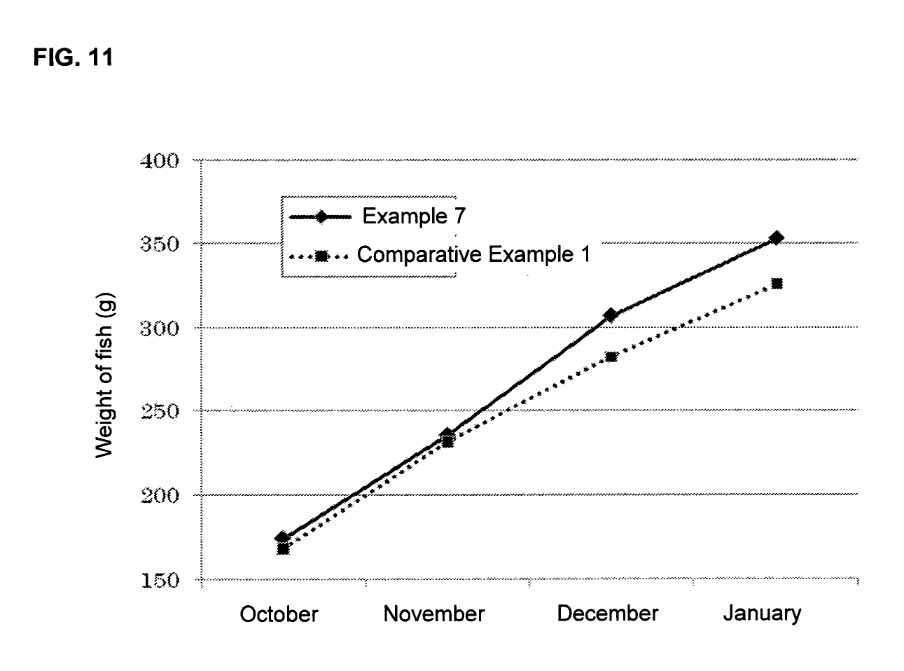

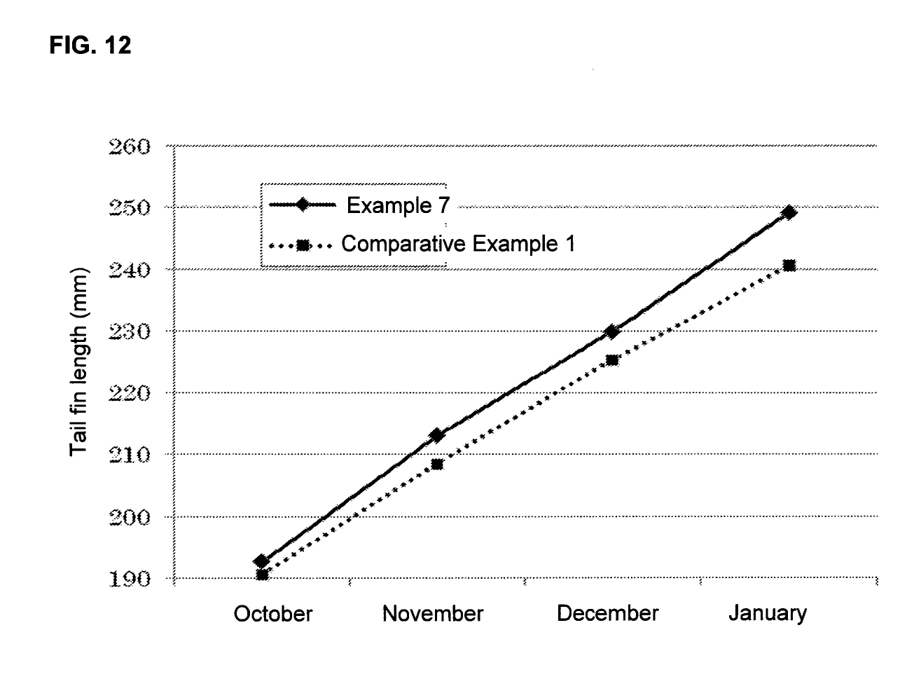

The feeding was started on August, and body weight (BW) and tail fin length (FL) of red sea bream was measured once a month from October. FIG. 11 shows the change in BW. FIG. 12 shows the change in FL. The growth-promoting effect caused by the feed of Example 7 was prominent in cold season during November to January.

### 4.2 Evaluation of the Amount of Feed Eaten by Fishes

The amount of the feed according to the present invention eaten by red sea breams was evaluated. The evaluation was based on four levels: eating very well (∘*), eating well (∘), eating normally (Δ), not eating well (×).

Table 6 shows the results of the evaluation. The feed of Example 7 was eaten by red sea breams in very high degree, showing the feed of Example 7 was higher in the amount of feed eaten by fishes compared to that of Comparative Example 1.

TABLE 6

| | the amount of feed eaten by |
|---|---|
| | fishes |
| Example 7 | ∘* |
| Comparative | x |
| Example 1 | |

### 5. Verifying Effect of Feed Containing Fly Larvae

In addition, feed for fish containing fly larvae was produced and its effect was verified. As housefly larvae, the ones having been obtained from organic waste and having been heat-treated by boiling (about 10 minutes; about 100 degrees Celsius) and dried under the sun were used. Four kinds of feeds for fish (Example 8, Example 9, Example 10, and Comparative Example 1) were produced. Table 7 shows the composition of feed ingredients contained in 100 g (by dried weight) of the produced feed for fish. The feed of Example 8 contained housefly larvae in 5 wt % by dried weight based on the entire feed ingredients, and in 10 wt % by dried weight based on the entire animal ingredients. The feed of Example 9 contained housefly larvae in 25 wt % by dried weight based on the entire feed ingredients, and in 50 wt % by dried weight based on the entire animal ingredients. The feed of Example 10 contained housefly larvae in 50 wt % by dried weight based on the entire feed ingredients, and in 100 wt % by dried weight based on the entire animal ingredients.

TABLE 7

| Feed | | | | |
|---|---|---|---|---|
| Ingredients | Exam- | Exam- | Exam- | Comparative |
| (g) | ple 8 | ple 9 | ple 10 | Example 1 |
| Housefly pupae | 5 | 25 | 50 | 0 |
| Fishmeal | 45 | 25 | 0 | 50 |
| Wheat | 24 | 24 | 24 | 24 |
| Soybean | 24 | 24 | 24 | 24 |
| Vitamin | 1 | 1 | 1 | 1 |
| CMC | 1 | 1 | 1 | 1 |

As test fishes, 96 red sea breams born on the year whose body weight (BW) was 21.5±2.3 g and tail fin length (FL) was 100.3±2.8 mm were used. They were divided into four groups (24 fishes for each), and each of them was fed with corresponding feeds only, and the effects on the test fishes was analyzed. The feed was given two times a day, each time up to the satiation amount. The water temperature for feeding was 15.5 to 19.2 degrees Celsius.

### 5.1 Analysis of the Effect on Immunity Activation

Effects of feed on immunity activation in red sea bream was evaluated using white blood cell phagocytosis as an indicator. 2% of Proteose Peptone was administered into abdominal cavity of ten-day-old red sea bream. Then the red sea bream was fed for 96 hours, and neutrophil leached to the abdominal cavity was collected. Phagocytosis capability was evaluated using fluorescent latex beads (3 μm) as an object of phagocytosis. Neutrophil was cultured for 1 hour in culture fluid to which the beads were added. Then the ratio of the neutrophil ingested the latex beads (phagocytosis ratio) and the number of ingested latex beads per cell of neutrophil (phagocytosis beads number) was evaluated.

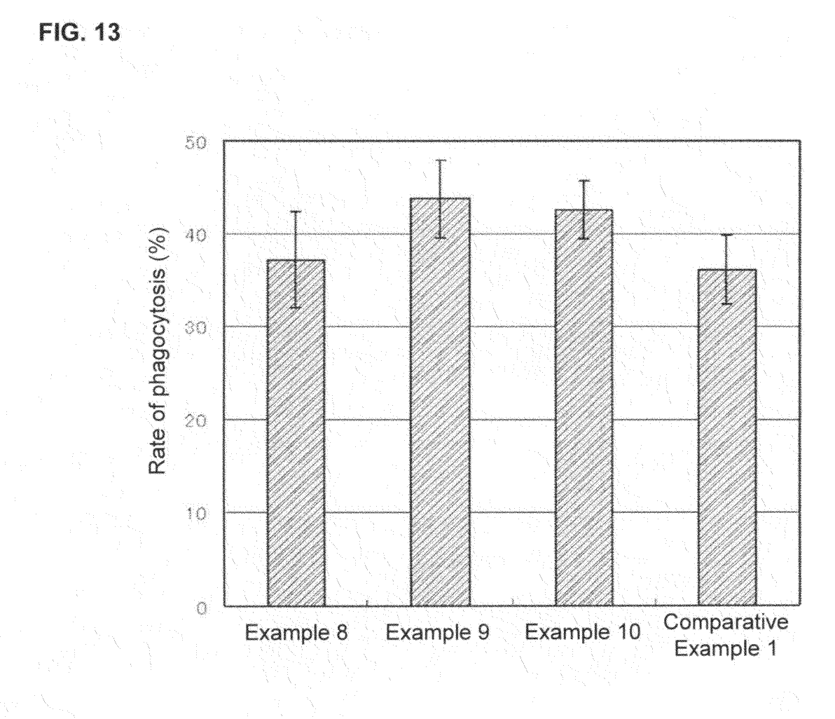

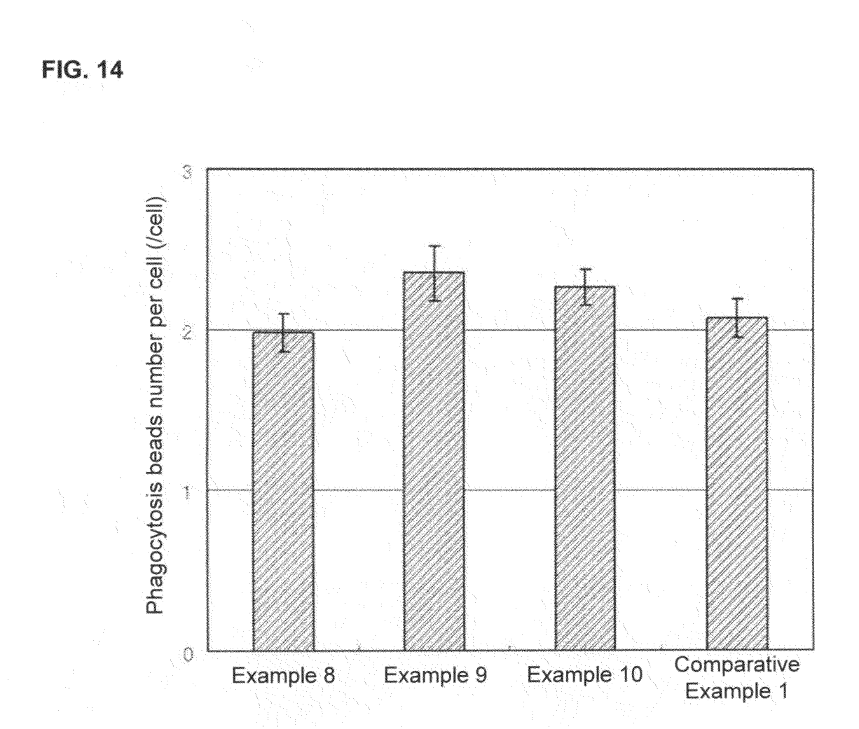

As shown in FIG. 13 and FIG. 14, the groups having been given the feeds of Examples 8 to 10 had tendency for having higher phagocytosis ratio and phagocytosis beads number compared to the group having been given the feeds of Comparative Example 1.

### 5.2 Analysis of Growth-Promoting Effect

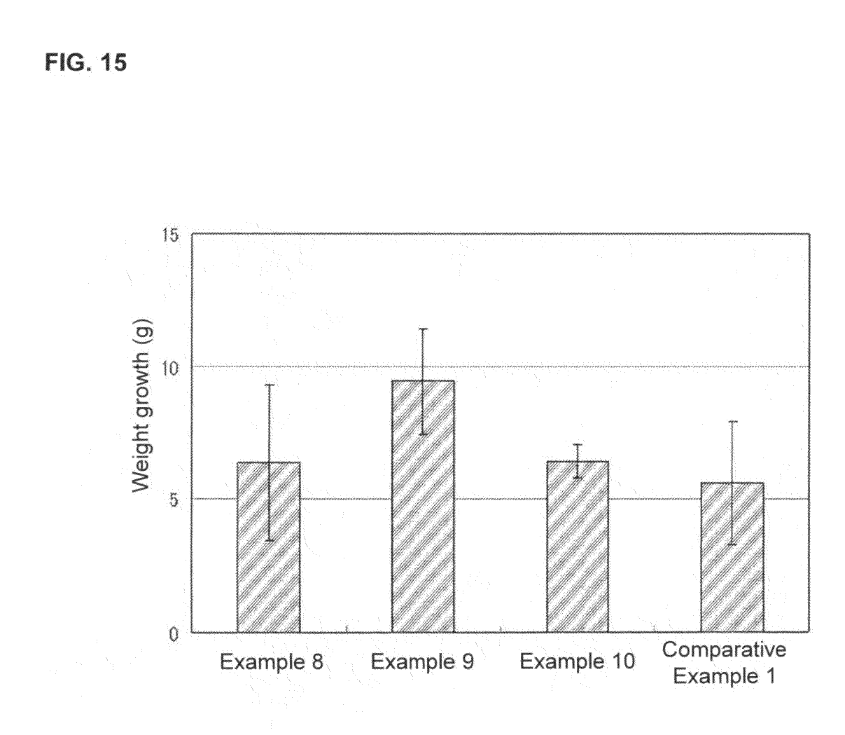

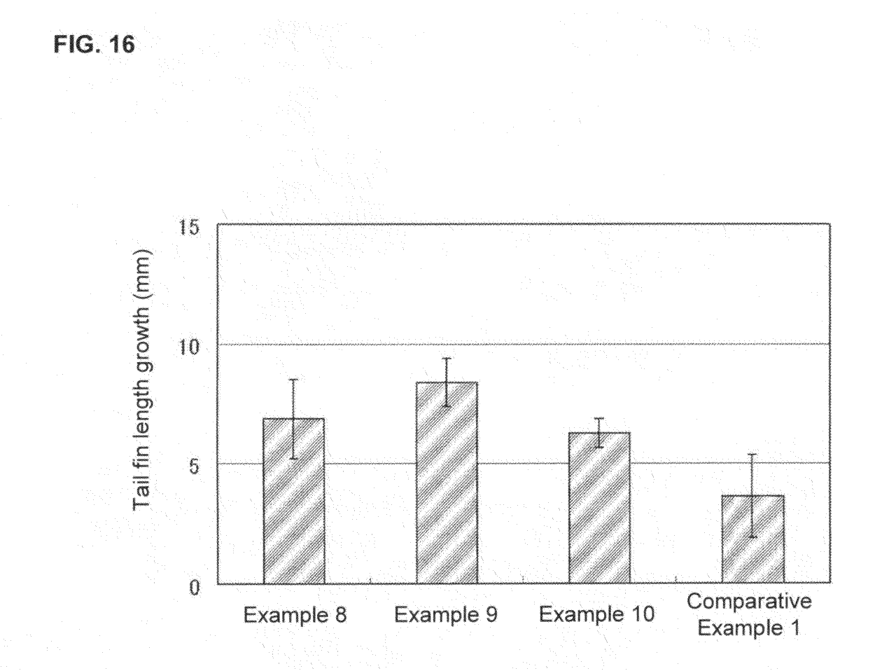

After breeding for 40 days, body weight (BW) and tail fin length (FL) of red sea bream was measured, and the growth amount was calculated based on the difference with the values before the experiment. As shown in FIG. 15 and FIG. 16, the groups having been given the feeds of Examples 8 and 9 had tendency for having high BW and high FL. The weight increase factor was 6.37 for the group having been given the feed of Comparative Example 1, 4.73 for Example 8, and 4.51 for Example 9. Thus, it was revealed that the fishes having eaten the feed according to the present invention grow efficiently.

### INDUSTRIAL APPLICABILITY

The feed for fish according to the present invention can be utilized for fish farming and fish breeding etc.

1. A feed for fish containing fly pupae or fly larvae.

2. The feed for fish according to claim 1, the fly pupae having been subjected to a heating process and the fly larvae having been subjected to a heating process.

3. The feed for fish according to claim 2, wherein the heating process is a process with high temperature and high pressure.

4. The feed for fish according to any of claims 1 to 3, containing the fly pupae or the fly larvae in about 0.05 to about 50 wt % by dry weight based on entire feed ingredients.

5. The feed for fish according to any of claims 1 to 4, containing the fly pupae or the fly larvae in about 0.1 to about 100 wt % by dry weight based on animal ingredients contained in the feed.

6. The feed for fish according to any of claims 1 to 5, containing the fly pupae or the fly larvae in about 0.5 to about 25 wt % by dry weight based on entire feed ingredients.

7. The feed for fish according to any of claims 1 to 6, containing the fly pupae or the fly larvae in about 1 to about 50 wt % by dry weight based on animal ingredients contained in the feed.

8. The feed for fish according to any of claims 1 to 7, containing the fly pupae in about 0.5 to about 7.5 wt % by dry weight based on entire feed ingredients.

9. The feed for fish according to any of claims 1 to 8, containing the fly pupae in about 1 to about 15 wt % by dry weight based on entire feed ingredients.

10. The feed for fish according to any of claims 1 to 9, containing the fly larvae in about 5 to about 50 wt % by dry weight based on entire feed ingredients.

11. The feed for fish according to any of claims 1 to 10, containing the fly larvae in about 10 to about 100 wt % by dry weight based on animal ingredients contained in the feed.
